(19) United States
(12) Patent Application Publication
(10) Pub. No.: US 2026/0030652 A1
(43) Pub. Date: Jan. 29, 2026

(54) MODEL INTEGRATION FOR CONTENT CAMPAIGN ATTRIBUTION

(71) Applicant: Adobe Inc., San Jose, CA (US)

(72) Inventors: Lijing WANG, Redwood City, CA (US); Yuan YUAN, Sunnyvale, CA (US); Hong Zhi ZOU, San Francisco, CA (US); Michael Zikai GAO, San Francisco, CA (US); Bei HUANG, Mountain View, CA (US); Jin XU, Sunnyvale, CA (US); Qilong YUAN, San Jose, CA (US); Zhenyu YAN, Cupertino, CA (US)

(21) Appl. No.: 18/780,749

(22) Filed: Jul. 23, 2024

(51) Int. Cl. G06Q 30/0242

(52) U.S. Cl. CPC G06Q 30/0243; G06Q 30/0246

(57) ABSTRACT

Some aspects relate to technologies providing a framework for integrating two machine learning models to determine an attribution of a content campaign to conversions. In accordance with some aspects, a first machine learning model (such as a media mix modeling model) generates a first attribution of a content campaign to intermediate events. A second machine learning model (such as a multi-touch attribution model) generates a second attribution of the intermediate events to conversions. An attribution of the content campaign to the conversions is determined as a function of the first attribution and the second attribution.

### BACKGROUND

Online analysis tools often utilize various attribution models to analyze data. An attribution model generally refers to a machine learning model that determines credit (i.e., attribution) for an outcome (i.e., a conversion, such as an online order). Upon generating attributions via an attribution model, such attributions can be used by the analysis tool for various applications, such as return on interest (ROI) analysis, budget optimization analysis, and the like.

One challenge of conventional attribution models is the difficulty of tracking attribution for content campaigns. Content campaigns, also known as upper funnel campaigns, are designed to build brand awareness and attract new audiences by focusing on engaging content rather than direct sales pitches. Examples of content campaigns include billboards advertisements, television advertisements, social media advertisements, content marketing initiatives like blog posts or videos to establish expertise, branded events or sponsorships for in-person engagement, search engine optimization efforts to increase organic visibility, targeted display advertising, and/or any other advertisements that seek to build brand awareness. These strategies aim to introduce the brand to potential customers and lay the groundwork for future interactions and conversions.

### SUMMARY

Some aspects relate to technologies providing a framework that integrates two separate machine learning models to determine attributions of content campaigns to conversions. In accordance with some aspects, an analytics system integrates a first machine learning model (such as a media mix modeling model) and a second machine learning model (such as a multi-touch attribution model) to determine attributions of content campaigns to conversions. The first machine learning model generates an attribution of content campaigns to intermediate events, which are touchpoints in which a potential customer takes an action that indicates engagement or interest in advertised content or brands associated with a content campaign. In contrast to some conventional attribution models (e.g., using traditional media mix modeling) that determine the attribution of content campaigns to conversions, the first machine learning model of the present disclosure generates the attribution of content campaigns to intermediate events. The second machine learning model generates an attribution of the intermediate events to conversions. The second machine learning model can be a multi-touch attribution model (MTA) that, unlike traditional MTAs, treats the intermediate events as a particular type of touchpoint to determine the attribution of the intermediate events to conversions. Using the attribution of a content campaign to intermediate events and the attribution of intermediate events to conversions, the analytics system generates the attribution of the content campaign to the conversions. As such, the analytics system effectively merges the first machine learning model and the second machine learning model to determine an attribution of a specific content campaign to conversions.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a block diagram showing an example for generating attributions to intermediate events using a first machine learning model in accordance with some implementations of the present disclosure;

FIG. 3 is a block diagram showing an example for generating attributions to conversions using a second machine learning model in accordance with some implementations of the present disclosure;

FIG. 4 is a block diagram showing an example generating attributions of content campaigns to conversions in accordance with some implementations of the present disclosure;

FIG. 5 is a flow diagram showing a method for determining an attribution of a content campaign to conversions in accordance with some implementations of the present disclosure;

FIG. 6 is a flow diagram showing a method for generating an output that comprises an attribution of each content campaign to intermediate events in accordance with some implementations of the present disclosure;

FIG. 7 is a flow diagram showing a method for generating an output that comprises an attribution of each type of touchpoint to conversions in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “content campaign” refers to a set of strategic activities in which content, such as advertisements, is deployed through one or more channels (i.e., different types of media, such as print, television, radio, and online platforms) to build brand awareness for a product/service provider and introduce members of the public to the provider and the products and/or services offered by the provider. Content campaigns typically reach potential customers during a stage where the potential customer has the lowest intention to purchase a product and/or service offered by a provider. In some aspects, a content campaign is an upper funnel campaign.

The term “content campaign data” refers to data collected for a content campaign, such as the channel(s) used, spends, and impression volumes associated with the content campaign. Content campaign data is available only at an aggregate level and not at an individual (i.e., customer or potential customer) level. For example, content campaign data can include the total amount of spend that a provider invests into a specific content campaign (in some cases, over a certain time period). In addition, content campaign data can include an impression volume, which represents the total number of times (e.g., within a specified time period) that content from the content campaign is displayed, presented, and/or otherwise exposed to potential customers.

The term “other campaigns” is used herein to refer to a set of strategic activities that try to persuade people to purchase a product or service offered by a provider. For example, a provider sending an email with a promotion for a specific product or service offered by the provider would fall under other campaigns. Other campaigns often target different key performance indicators (KPI) and seek to influence (e.g., increase) conversions of products and/or services offered by the provider. In some aspects, other campaigns are lower funnel campaigns.

The term “other campaign data” refers to data collected for other campaigns. For example, other campaign data may include the type of advertisement that is used in a lower funnel campaign. In some cases, the other campaign data for some other campaigns comprises individual-level data. However, the other campaign data for some other campaigns may not have individual level data.

The term “individual-level data” refers to data associated with a particular customer or potential customer. For example, individual-level data can include the customer or potential customer's personal information, individual-level touchpoint data, and/or individual-level conversion data.

A “touchpoint” refers to any interaction or contact between a brand and customer during the customer's journey until conversion. Examples of touchpoints include, but are not limited to, sending an email to the customer, displaying an advertisement on a web browser when the customer searches the provider, calling the customer to inform the customer of potential savings, sending targeted advertisements on social media platforms, populating paid advertisements at the top of a webpage after a query from a user, and more.

The term “individual-level touchpoint data” refers to information collected for each touchpoint for a particular individual. The individual-level touchpoint data for a given individual can include, for instance, a type of touchpoint (e.g., email, display advertisement, etc.) and a timestamp for when the touchpoint occurred.

The term “individual-level conversion data” refers to data collected regarding a conversion by an individual. For instance, the individual-level conversion data for a conversion can include information such as the product or service purchased, the platform on which the conversion occurred, and a timestamp for when the conversion occurred.

A “conversion” refers to the act of a customer purchasing a product and/or service offered by a provider or performing some other specified action desired by the provider.

An “intermediate event” refers to a touchpoint in which a potential customer takes an action that indicates engagement or interest in the advertised content or brand associated with a content campaign. Examples of intermediate events include free signups (e.g., creating an account with a provider), free trials, adding items to cart, clicks on an advertisement, website visits, content downloads, email sign-ups, and more. As will be described in more detail herein, an intermediate event is used to link two different machine learning models to facilitate determining attribution of a content campaign to conversions.

The term “intermediate event data” refers to data regarding intermediate events. In some aspects, this can include the total number of intermediate events of a particular type that have occurred within a given time period. For example, the total number of signups in a given day would be considered intermediate event data. In some aspects, intermediate event data can be “individual-level intermediate event data,” which refers to data associated with a particular customer or potential customer regarding a specific intermediate event.

An “attribution” refers to the amount of influence that marketing activities, such as content campaigns, other campaigns, and touchpoints, have on downstream events, such as intermediate events or conversions. In accordance with some aspects of the technology described herein, an attribution can refer to the amount of influence that: a content campaign has on intermediate events, intermediate events have on conversions, and a content campaign has on conversions. In some aspects, an attribution is measured by a percentage. Attribution to conversions can comprise attribution to: conversions for a specific product or service, conversions for a category of products or services, or conversions for any combination of products and/or services for a provider.

The term “media mix modeling” (MMM) refers to a statistical analysis technique used in marketing to determine the most effective allocation of resources across different advertising channels (e.g., media). MMM aims to optimize the distribution of advertising budgets to maximize the return on investment (ROI) or achieve other specific marketing objectives, such as increasing brand awareness or driving sales.

The term “multi-touch attribution model” (MTA) refers to a model that applies machine learning techniques to marketing attribution modeling. An MTA model determines the contribution of each touchpoint to conversions. Traditionally, an MTA operates on individual-level data.

An “environmental factor” refers to any external factor that could potentially affect any given intermediate event. For example, environmental factors can include the SP500 (e.g., as a proxy for the economic environment, which can influence consumer behavior), promotions (e.g., any promotions or special offers that might be running concurrently with the content campaign), seasons (e.g., temporal factors like time of the year, holidays, or specific seasons, which can have a significant impact on consumer behavior and signup trends), and other factors that are capable of affecting intermediate events.

The term “environmental variables” refers to anything that can be associated with a conversion. For example, environmental variables can include details of any specific day in which a conversion was made, including the day of the week, the time of day, whether the day was a holiday or not. Moreover, the time between intermediate events and conversions and/or the time between touchpoints and conversions can also be considered an environmental variable.

### Overview

In the realm of data-driven decision-making, analytics systems often provide for attributions to provide valuable insights from advertisements and other marketing activities. For example, some analytics systems provide the attribution of marketing campaigns to conversions. Rather than manually tracking and quantifying the factors that can be attributed to conversions, analytics systems offer a more efficient mechanism for processing data and determining attributions of that data to conversions. As such, analytics systems serve as powerful tools for efficiently monitoring and processing data, presenting a detailed overview of the attributions of marketing campaigns to conversions.

However, tracking the attributions of content campaigns to conversions entails a challenge of its own. The primary goal of a content campaign is to enhance brand awareness and reach new users. The content campaign stage is typically where consumers have the lowest purchase intention. Advertisers utilize content campaigns with the hope that users will develop an interest in a company's brand, products, and/or services and ultimately achieve the long-term goal of getting people to buy products (e.g., make conversions). Unlike other campaigns, such as re-targeting ads (e.g., targeted ads on social media sites, for instance), content campaigns are more frequently placed in channels with greater exposure, such as billboards, TV, audio, Out of Home advertising (OOH), Connected TV (CTV), etc. Eventually, content campaigns can result in people purchasing a company's products. However, a drawback of these channels typically used by content campaigns is the difficulty in attributing each content campaign directly to conversions. For example, the revenues and/or contributions that are brought in by content campaigns are usually very hard to measure, because these content campaigns are hard to track down at the individual level (e.g., at the customer level).

Compared to the vast volume of advertisement placements, very little (if any) individual-level touchpoint data is collected for content campaigns. For traditional advertising mediums like TV and billboards, it's particularly challenging, if not nearly impossible, to gather accurate individual-level touchpoint data on the number of impressions the advertisements have on individuals. Moreover, collecting individualized data regarding who exactly has seen these advertisements is even more formidable.

This poses a challenge for measuring the revenue generated by content campaigns using conventional attribution models. For example, some conventional models, such as traditional multi-touch attribution models (MTAs), determine attributions to conversions based on individual-level data. However, such models can't be used to directly measure the contributions of content campaigns to conversions since individual-level data is not available for the content campaigns. Other conventional attribution models, such as those employing conventional media mix modeling (MMM), attempt to directly determine the attribution of content campaigns to conversions. In such approaches, content campaigns are directly incorporated as an independent variable into the conventional MMM, and the final revenue generated from the content campaign is the dependent variable. However, since the primary effect of content campaigns is to lift brand awareness rather than directly generate revenue, content campaigns often happen at the early stage of customer acquisition. Consequently, the impact of these content campaigns might be underestimated and absorbed by other campaigns that happen at later stages. In other words, the use of MMMs to correlate content campaigns with conversions lacks accuracy. As such, conventional models are not suitably configured to solve this issue.

Aspects of the technology described herein improve the functioning of the computer itself in light of these shortcomings in existing technologies by providing a platform that merges two separate machine learning models to more effectively and efficiently generate attributions of content campaigns to conversions. In particular, an analytics system utilizes a first machine learning model (e.g., a model employing MMM) that generates the attribution of content campaigns to intermediate events, utilizes a second machine learning model (e.g., an MTA model) that generates the attribution of the intermediate events to conversions, and merges the two machine learning models into a multi-stage model that generates an attribution of a specific content campaign to conversions. Here, the intermediate events are treated as the dependent variable in the first machine learning model and an independent variable (i.e., a type of touchpoint) in the second machine learning model, which allows the two machine learning models to be synergized into a multi-stage model. As such, the analytics system described herein provides a multi-stage model that integrates two machine learning models to determine the attribution (e.g., the assignable percentage) of a content campaign to conversions (e.g., purchases) of a product or service.

In operation, the analytics system retrieves and analyzes data that has been collected and stored in a data store. The data stored in the data store and used by the analytics system can include, for instance, content campaign data, other campaign data, individual-level data (e.g., individual-level touchpoint data and individual-level conversion data), intermediate event data environmental factors, and environmental variables. Using data stored in the data store, the analytics system employs the first machine learning model to generate the attribution of a content campaign to intermediate events (e.g., free signups for an account to a goods and/or services provider) and also uses the second machine learning model to generate the attribution of the intermediate events to subsequent conversions (e.g., purchases of goods or services from the provider). The analytics system generates the attribution of the content campaign to the conversions as a function of the attribution of the content campaign to the intermediate events and the attribution of the intermediate events to the conversions.

In some examples, the first machine learning model accesses content campaign data and other campaign data for a plurality of content campaigns that includes a content campaign. For example, the first machine learning model could generate an attribution of a content campaign to the number of free signups (e.g., creating an account) with a provider. Furthermore, the first machine learning model accesses environmental factors and intermediate event data for the intermediate events. Utilizing the content campaign data, the other campaign data, the intermediate event data, and the environmental factors as input, the first machine learning model generates an output that comprises an attribution of each of the content campaigns to the intermediate events. As such, the first machine learning model measures the attribution of content campaigns to intermediate events.

In some aspects, the second machine learning model accesses individual-level touchpoint data for various different types of touchpoints for a number of individuals. The individual-level touchpoint data includes individual-level intermediate event data for intermediate events. The second machine learning model also accesses environmental variables and individual-level conversion data regarding conversions for the individuals. For instance, the individual-level conversion data for a conversion can include information such as the product or service purchased, the platform on which the conversion occurred, and a timestamp for when the conversion occurred. Furthermore, utilizing the individual-level touchpoint data, the individual-level conversion data, and the environmental variables as input, the second machine learning model generates an output that comprises an attribution of each type of touchpoint (including the intermediate events as one specific type of touchpoint) to the conversions. Accordingly, the output of the second machine learning model includes attributions of the intermediate events to conversions.

Therefore, because the first machine learning model measures the attribution of content campaigns to intermediate events, and the second machine learning model measures the attribution of intermediate events to conversions, the analytics system combines the two models into a multi-stage model with intermediate events being the pivotal link. As such, the analytics system described herein employs an unconventional solution to integrate two separate machine learning models in a way that more effectively (e.g., as compared to prior solutions) determines the attribution of a content campaign to conversions.

Aspects of the technology described herein provide a number of improvements over existing technologies. For example, unlike using MMM to determine the attribution of content campaigns to conversions, which likely underestimates the impact of content campaigns on conversions, this technology introduces a framework that employs a first machine learning model (e.g., one using MMM) to generate the attribution of content campaigns on intermediate events, employs a second machine learning model to generate the attribution of intermediate events on conversions, and combines the two machine learning models to produce a more accurate attribution of content campaigns on conversions. By utilizing intermediate events as a pivotal link between the two machine learning models to provide a multi-stage model, the technology described herein is able to factor in individual-level data into the calculation of the attribution of content campaigns to conversion, which was not previously possible. This integration offers a novel approach to generating attribution of content campaigns to conversions, which are typically challenging to quantify via conventional attribution models. Additionally, the technology described herein yields a more detailed level of information than other methodologies, drawing from the strengths of the two machine learning models.

### Example System for Content Campaign Attribution Via Model Integration

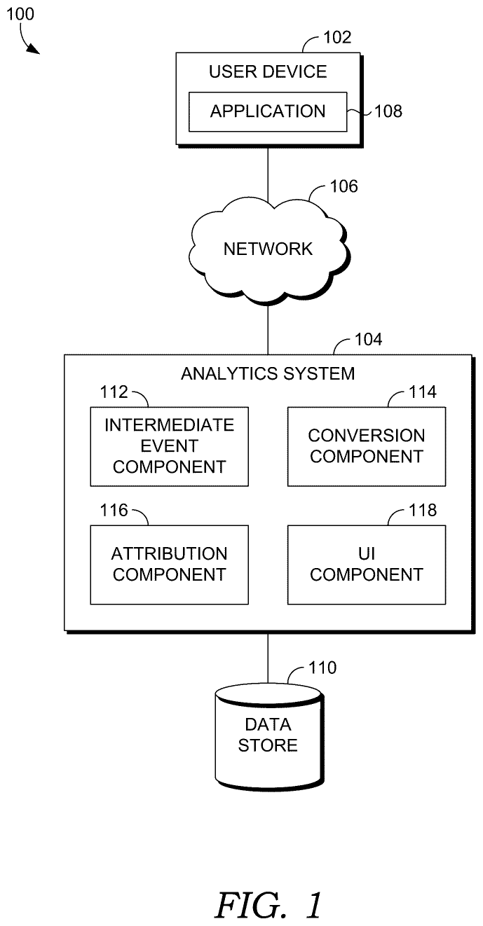

With reference now to the drawings, FIG. 1 is a block diagram illustrating an exemplary system 100 for determining attribution of content campaigns to conversions in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

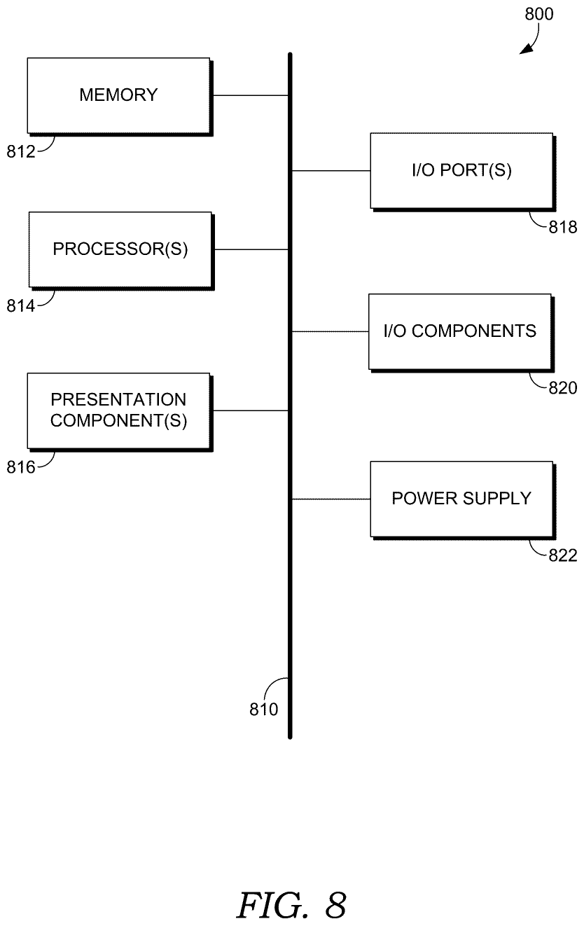

The system 100 is an example of a suitable architecture for implementing certain aspects of the present disclosure. Among other components not shown, the system 100 includes a user device 102 and an analytics system 104. Each of the user device 102 and the analytics system 104 shown in FIG. 1 can comprise one or more computer devices, such as the computing device 800 of FIG. 8, discussed below. As shown in FIG. 1, the user device 102 and the analytics system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and servers can be employed within the system 100 within the scope of the present technology. Each can comprise a single device or multiple devices cooperating in a distributed environment. For instance, the analytics system 104 could be provided by multiple server devices collectively providing the functionality of the analytics system 104 as described herein. Additionally, other components not shown can also be included within the network environment.

The user device 102 can be a client device on the client-side of operating environment 100, while the analytics system 104 can be on the server-side of operating environment 100. The analytics system 104 can comprise server-side software designed to work in conjunction with client-side software on the user device 102 so as to implement any combination of the features and functionalities discussed in the present disclosure. For instance, the user device 102 can include an application 108 for interacting with the analytics system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the analytics system 104 remain as separate entities. While the operating environment 100 illustrates a configuration in a networked environment with a separate user device and analytics system, it should be understood that other configurations can be employed in which aspects of the various components are combined.

The user device 102 comprises any type of computing device capable of use by a user. For example, in one aspect, a user device can be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the analytics system 104 via the user device 102.

The analytics system 104 determines the attribution (e.g., the assignable percentage) of a content campaign to conversions (e.g., purchases) of a product or service. In some instances, the analytics system 104 retrieves and analyzes data that has been collected and stored in a data store 110. The data stored in the data store 110 and used by the analytics system 104 can include, for instance, content campaign data, other campaign data, individual-level data (e.g., individual-level touchpoint data and individual-level conversion data), and intermediate event data. The data store 110 can store data in a variety of different formats that facilitate retrieval of data for determining the attribution of a content campaign to conversions. In some aspects, the data is stored as structured data. The structured data can employ a schema having multiple attributes. For instance, the structured data can comprise tabular data represented as a table in rows and columns, where each row corresponds to a record, and each column corresponds to an attribute. An attribute (e.g., a column in tabular data) corresponds to a dimension, metric, characteristic, feature, or property within the schema of the structured data. An attribute is identified using an attribute name and can comprise attribute values that are either numerical data (i.e., a numeric attribute) or non-numerical data (i.e., a non-numeric attribute). Numerical data comprises data in the form of numbers, including discrete or continuous values. Non-numerical data comprises data in the form of names or labels. It should be understood that while tabular data is provided as an example of structured data, the data store 110 can store other forms of structured data.

Among other functions, the analytics system 104 retrieves data from the data store 110 and determines the attribution of a content campaign (e.g., upper funnel campaign) to conversions of a product or service. As will be described in further detail below, the analytics system 104 employs a first machine learning model to determine the attribution of a content campaign to intermediate events (e.g., free signups for an account to a goods and/or services provider) and a second machine learning model to determine the attribution of the intermediate events to subsequent conversions (e.g., purchases of goods or services from the provider). The analytics system 104 then determines the attribution of the content campaign to the conversions as a function of the attribution of the content campaign to the intermediate events and the attribution of the intermediate events to the conversions.

As shown in FIG. 1, the analytics system 104 includes an intermediate event component 112, a conversion component 114, an attribution component 116, and a user interface component 118. The components of the analytics system 104 can be in addition to other components that provide further additional functions beyond the features described herein. The analytics system 104 can be implemented using one or more server devices, one or more platforms with corresponding application programming interfaces, cloud infrastructure, and the like. While the analytics system 104 is shown separate from the user device 102 in the configuration of FIG. 1, it should be understood that in other configurations, some of the functions of the analytics system 104 can be provided on the user device 102. Additionally, while the components are shown as part of the analytics system 104, in other configurations, one or more of the components can be provided at another location not shown in FIG. 1. The components can be provided by a single entity or multiple entities.

In some aspects, the functions performed by components of the analytics system 104 are associated with one or more applications, services, or routines. In particular, such applications, services, or routines can operate on one or more user devices, servers, can be distributed across one or more user devices and servers, or be implemented in the cloud. Moreover, in some aspects, these components of the analytics system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The intermediate event component 112 generates an attribution of a content campaign to intermediate events of a particular type. An intermediate event is a type of touchpoint in which a potential customer takes an action that indicates engagement or interest in the advertised content or brand associated with a content campaign (e.g., upper funnel campaign). Content campaigns typically reach potential customers during a stage where the potential customer has the lowest purchase intention. An intermediate event may not directly lead to a conversion or sale, because intermediate events typically occur after initial exposure to a content campaign but before the potential customer reaches the final conversion stage (e.g., purchasing a product and/or service and becoming a customer).

In contrast to conventional media mix modeling (MMM) that determines the attribution of content campaigns to conversions, the intermediate event component 112 employs a machine learning model (that could employ MMM) to generate the attribution of content campaigns to intermediate events. Some examples of intermediate events include, but are not limited to, free signups (e.g., to a service and/or goods provider), free trials, adding items to cart, clicks on an ad, website visits, content downloads, email sign-ups, and more. In some examples, the intermediate event component 112 determines the impact of a content campaign on intermediate events of a particular type (i.e., a targeted intermediate event type). For example, the intermediate event component 112 could generate an attribution of a content campaign to the number of free signups (e.g., creating an account) with a provider.

The input to the intermediate event component 112 comprises content campaign data for content campaigns that could contribute to downstream intermediate events of a targeted intermediate event type, other campaign data that could contribute to the downstream intermediate events, and environmental factors. The content campaign data and other campaign data could include, for instance, campaign spend and/or impression counts. An impressions count represents the number of impressions generated by a content campaign or other campaign. An impression is an instance of content from a campaign being presented to a customer or potential customer. As such, an impression count is a useful metric to help understand how exposure to the content of campaigns correlates with the number of occurrences of a specified intermediate event. Environmental factors encompass a range of external factors that could potentially affect intermediate events (e.g., such as market prices, promotions, time of year, etc.). The output of the intermediate event component 112 can comprise an attribution of each content campaign and each other campaign to intermediate events.

The intermediate event component 112 employs a machine learning model to determine the attributions of content campaigns and other campaigns to intermediate events based on the content campaign data, intermediate event data, and environmental factors. In some aspects, the machine learning comprises an MMM framework in which the number of intermediate events (e.g., number of free sign-ups) is used as the dependent variable and the independent variables include: aspects of the content impression data (e.g., spend, impression count), aspects of the other campaign data (e.g., spend, impression count), and environmental factors.

Generally, any type of touchpoint could be used as the intermediate event. In some aspects, the type of intermediate event for which attributions are determined by the intermediate event component 112 is configurable. For instance, a user could select a particular type of touchpoint as the intermediate event type. In some aspects, the analytics system 104 (e.g., via the user interface component 118) provides a user interface that presents available touchpoint types from which a user can select to set as the intermediate event type.

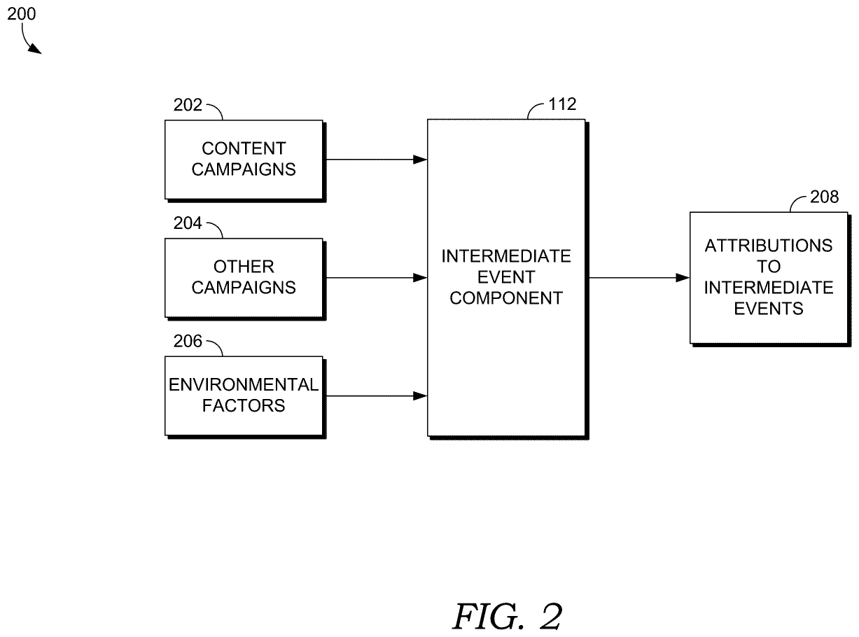

FIG. 2 provides a block diagram showing an example operation of the intermediate event component 112. In this example, the intermediate event component 112 generates the attribution of a content campaign to intermediate events of a specified intermediate event type. Because the purpose of a content campaign is to attract people to become familiar with the provider and/or the services or products that are provided by the provider, content campaigns generally are not concerned with individual-level data (e.g., data associated with a particular customer) that may be correlated with a content campaign. Moreover, individual-level data is often difficult to trace back to a specific content campaign. However, FIG. 2 provides an example of inputs that can be used by the intermediate event component 112 to output attribution of a content campaign to intermediate events (which can be based on individual-level data).

In some aspects, the intermediate event component 112 accesses content campaign data, other campaign data, and environmental factors associated with a content campaign. For instance, in the example embodiment depicted in FIG. 2, the intermediate event component 112 accesses and processes data associated with content campaigns 202, other campaigns 204, and environmental factors 206. In cases in which the intermediate event component 112 processes such data, as well as other inputs (e.g., any other information associated with a relevant content campaign), the output of the intermediate event component 112 includes attributions of content campaigns to intermediate events 208.

Content campaign data (e.g., associated with content campaigns 202) can encompass different channels (e.g., modes of advertisement), spends, and/or impression volumes. For example, content campaign data can include the channels of content campaigns, such as billboards, TV, audio, out-of-home advertising (OOH), connected TV (CTV), social media advertisements, and/or any other advertisements that seek to build brand awareness. In some instances, content campaign data can include the amount of spend that a provider invests into a specific content campaign, and the amount of spend can be based on specific time periods (e.g., daily, weekly, monthly, yearly, and/or any specific day, month, season, year, or any other time period). In other instances, the content campaign data can include impression volumes. Impression volumes represent the number of times (e.g., within a specified time period) that content from the content campaigns 202 are displayed and/or exposed to potential customers. For example, impression volumes for each channel may be aggregated by day, week, month, season, year, and/or any other period of time. For instance, if an advertisement is played during a podcast, the intermediate event component 112 may process how many times that advertisement was played during that podcast in any given day.

In addition to the content campaign data of content campaigns 202, the intermediate event component 112 receives other campaign data associated with other campaigns 204. In contrast to content campaigns 202, other campaigns 204 generally seek to do more than promote brand awareness. Other campaigns 204 often target different key performance indicators (KPI) and seek to influence (e.g., increase) conversions of products and/or services offered by the provider. These other campaigns 204 are different from content campaigns 202 in that the content campaigns 202 typically do not try to persuade people to convert (e.g., purchase) a product or service. As such, the other campaigns 204 (e.g., lower funnel campaigns, such as ROI campaigns) target people who are already interested in purchasing a product and/or service from the provider. For example, a provider sending an email with a promotion for a specific product or service offered by the provider would fall under other campaigns 204. In another illustrative example, a potential customer could search on a web browser for a specific product offered by a provider, then the potential customer receives a targeted advertisement for the product during the search. In this example, because the potential customer is already searching for a product offered by the provider, the potential customer will likely receive an advertisement from the provider to purchase something, which would make this advertisement fall under other campaigns 204 (e.g., an ROI campaign) and not content campaigns 202.

After receiving content from one or more other campaigns 204, a potential customer could decide to participate in an intermediate event (e.g., such as completing a free signup with a provider) instead of purchasing a product and/or service. Therefore, other campaign data is relevant (e.g., could have an impact) in determining the attribution of content campaigns to intermediate events. Accordingly, other campaign data is used as an input to the intermediate event component 112.

Another input to the intermediate event component 112 includes environmental factors 206. In some instances, environmental factors 206 include a range of external factors that could potentially affect any given intermediate event (e.g., such as free signups). For example, environmental factors 206 may include the SP500 (e.g., as a proxy for the economic environment, which can influence consumer behavior), promotions (e.g., any promotions or special offers that might be running concurrently with the content campaign), seasons (e.g., temporal factors like time of the year, holidays, or specific seasons, which can have a significant impact on consumer behavior and signup trends), and other factors that are capable of affecting intermediate events.

The three inputs illustrated in the example embodiment depicted in FIG. 2 are not the only inputs that can be processed by intermediate event component 112. Intermediate event component 112 can receive and process-individually, collectively, or in any combination-data associated with content campaigns 202, other campaigns 204, environmental factors 206, and any other type of data that is relevant in determining the attribution of content campaigns to intermediate events. For example, additional data such as outcomes of previous modeling efforts, the allocation of marketing spend, insights from marketing experiments, and the number of conversions, among other things, can be used as model input to the intermediate event component 112. In another example, the decay effect associated with each content campaign and/or other campaigns (e.g., the content campaign decay effect pattern based on when the respective campaign started and/or ended) can be used as hyperparameters to the model to take into account the effect of the recentness of the campaigns on the intermediate events.

The intermediate event component 112 processes the model input to measure the impact of content campaigns 202 on intermediate events. To do this, the intermediate event component 112 uses the datasets associated with the inputs (e.g., the content campaign data associated with content campaigns 202, the other campaigns data associated with the other campaigns 204, and the environmental factors 206). By analyzing these aggregated datasets, the intermediate event component 112 generates an estimate of how many (or percentage of) intermediate events can be attributed to each content campaign. Thus, the intermediate event component 112 processes the inputs and provides output(s) in the form of attributions to intermediate events 208.

With reference again to FIG. 1, the conversion component 114 generates attributions of intermediate events of a particular type (e.g., free sign-ups) to conversions. The conversion component 114 can determine attribution of the intermediate events to conversions of a specific product or service, a category of products or services, and/or any number of products or services offered by a provider.

In some aspects, the conversion component 114 accesses individual-level data, including individual-level touchpoint data and individual-level conversion data, to generate an attribution of intermediate events to conversions. Touchpoints include any interaction or contact between a brand and customer during the customer's journey until conversion. Examples of touchpoints include, but are not limited to, the provider sending emails (e.g., potentially with promotions described therein) to the customer, displaying an advertisement on a web browser when the customer searches the provider, calling the customer to inform the customer of potential savings, sending targeted advertisements on social media platforms, populating paid advertisements at the top of a webpage after a query from a user, and much more. Individual-level touchpoint data is information associated with a touchpoint or any number of touchpoints. In accordance with aspects of the technology described herein, the conversion component 114 treats the intermediate events as touchpoints, thereby connecting the intermediate event component 112 and the conversion component 114.

The conversion component 114 uses a machine learning model to determine attributions to conversions. For example, the conversion component 114 can employ a multi-touch attribution model (MTA). Alternatively, or in addition, the conversion component 114 can employ another type of model, such as a rule-based model.

The conversion component 114 receives and processes input regarding conversions and input that can influence conversions, such as individual-level conversion data, individual-level touchpoint data, and other sources of data. In some examples, this data can be stored in data store 110, and the conversion component 114 accesses the data from the data store 110 to generate an attribution of intermediate events to conversions.

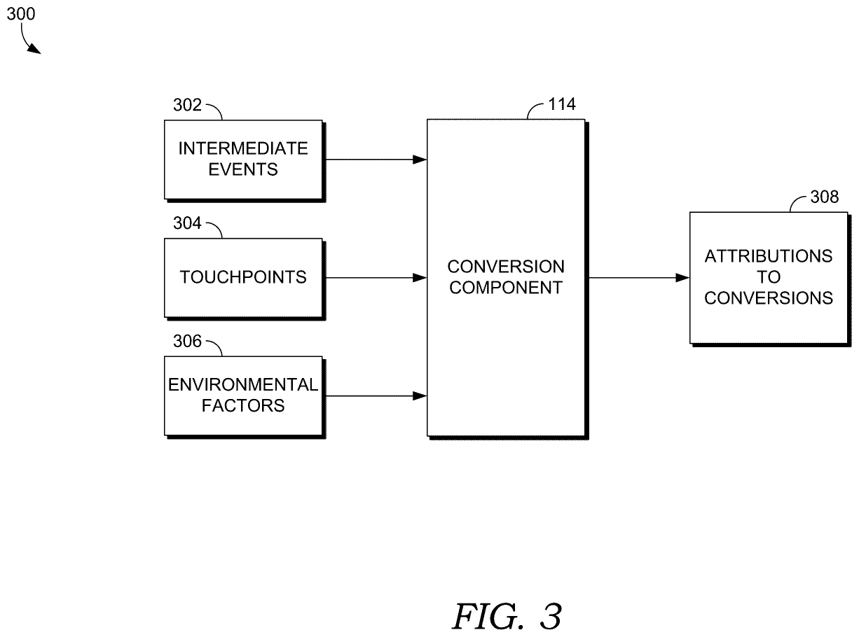

FIG. 3 provides a block diagram showing an example operation of the conversion component 114, in which the conversion component 114 accesses and processes individual-level conversion data, individual-level touchpoint data associated with intermediate events 302, individual-level data associated with touchpoints 304, and environmental variables 306. The output of the conversion component 114 includes attributions of intermediate events to conversions 308.

In accordance with some aspects, the conversion component 114 accesses individual-level conversion data, individual-level touchpoint data associated with intermediate events 302, and individual-level data associated with touchpoints 304. The conversion component 114 treats the intermediate events 302 as a specific type of touchpoint. In some aspects, the conversion component 114 processes (e.g., transforms) the data associated with intermediate events 302 and the touchpoints 304, along with the respective time lags (e.g., based on time stamps) associated with each intermediate event 302 and each touchpoint 304, into features that characterize different paths.

Paths reflect individual-level data (e.g., data associated with a specific potential customer or customer, such as individual-level conversion data and individual-level touchpoint data). Moreover, each path tracks specific touchpoints that lead to a conversion (i.e., a positive path) or no conversion (i.e., a negative path). As such, for positive paths, the conversion component 114 processes each path (e.g., individual-level touchpoint data) until a potential customer makes a purchase and becomes a customer. For example, Paul, a potential customer, can receive an advertisement at 1 P.M. on January 1^{st}, and this advertisement may be displayed on Paul's personal device, such as a smartphone. One hour later, at 2 P.M., the provider sends Paul an email advertisement containing a promotion. On January 2^{nd}, Paul decides to purchase a product offered by the provider. This sequence of events can be aggregated into a path associated with Paul. In this example, Paul maintains a positive path, meaning that he ended up purchasing a product from the provider who sent him the touchpoints 304.

In another example, Nancy can be considered as maintaining a negative path. In this example, Nancy is also exposed to two advertisements by the provider. However, unlike Paul, Nancy does not ultimately purchase a product or service offered by the provider. Despite maintaining a negative path, a path is nonetheless created for Nancy and every other potential customer by collecting the individual-level touchpoint data associated with that customer (e.g., such as touchpoints 304, including when the potential customer receives the touchpoint 304). Every path also includes the time lag associated with each path. The time lag is the amount of time between each touchpoint that a potential customer receives (e.g., for a negative path), as well as the amount of time between each touchpoint and a conversion for a customer (e.g., a positive path).

The conversion component 114 retrieves and processes the individual-level data (e.g., individual-level touchpoint data for the intermediate events 302 and the touchpoints 304, and individual-level conversion data) associated with a potential customer and/or a customer. For example, the conversion component 114 retrieves the time lag based on when a customer is exposed to an advertisement, the type of advertisement being exposed, and the identification information associated with the customer. In some instances, the conversion component 114 processes the individual-level data associated with a customer (e.g., the data regarding intermediate events 302 and touchpoints 304) and determines whether the path of that customer is positive or negative. Moreover, the conversion component 114 compares the differences between the paths across the customers (e.g., both potential customers and customers). After retrieving the individual-level data, the conversion component 114 generates a positive and negative path associated with each customer and potential customer based on whether the individual purchased or did not purchase a product or service.

In addition to retrieving the intermediate-level data associated with intermediate events 302 and touchpoints 304 and generating positive and negative paths, the conversion component 114 retrieves data on environmental variables 306. In some instances, environmental variables 306 mirror the environmental factors 206 of FIG. 2. In other instances, environmental variables 306 encompass anything that can be associated with a conversion. For example, environmental variables 306 can include details of any specific day in which a conversion was made, including the day of the week, the time of day, whether the day was a holiday or not. Moreover, the time between intermediate events 302 and/or touchpoints 304 that a potential customer or a customer experiences can also be considered an environmental variables 306. For example, John is exposed to a display advertisement seven days before his conversion in June, and that seven-day time lag, as well as the type of advertisement, is stored and associated with John. Continuing the example, John receives via email a promotion one day before conversion, and this information is also stored and associated with John. In other words, the time lag between intermediate events 302 and/or touchpoints 304 that a customer experiences before conversion can be provided as input to the conversion component 114 to take into account the effect of the recentness of the intermediate events 302 and/or touchpoints 304 on conversions. The time lag (e.g., the period between receiving a touchpoint and a conversion) is one of potentially several environmental variables 306.

After data for the environmental variables 306, the touchpoints 304, and the intermediate events 302 are retrieved, the conversion component 114 processes the data and generates the attributions (e.g., a percentage) of intermediate events to conversions 308. For example, prior to purchase, a group of potential customers are exposed to one or more display advertisements (e.g., a touchpoint 304). Additionally, within a week from the display of the advertisement, one thousand people made an account with the provider (e.g., one thousand people participated in the free signup intermediate event 302). In this example, the conversion component 114 essentially assigns credit to each display advertisement and each free signup. As such, the conversion component 114 determines how much of an impact that each of the display advertisements and each of the free signups have in terms of impacting the group of potential customers to purchase products and/or services offered by the provider. Alternatively, or in addition, if the time lag (e.g., the period between receiving an intermediate event 302 or touchpoint 304 and a conversion) is closer in time, that intermediate event 302 or touchpoint 304 associated with that smaller time period is determined to be more indicative of the conversion. In other words, the time at which each intermediate event 302 and touchpoint 304 occurred with respect to the time of the corresponding conversion impacts the attribution of each intermediate event 302 and touchpoint 304 to the corresponding conversion.

Accordingly, the conversion component 114 processes the inputs and outputs the attribution of the intermediate events 302 and/or each type of touchpoint 304 to conversions. As such, the conversion component 114 accesses individual-level touchpoint data for customers and/or potential customers, the individual-level touchpoint data comprising individual-level intermediate event data, and accesses individual-level conversion data for the customers and/or potential customers. Therefore, the individual-level data is taken as input, and the ultimate output from the conversion component 114 is the attribution of intermediate events to conversions 308. The output can also comprise attribution of each type of touchpoint other than the intermediate events to the conversions.

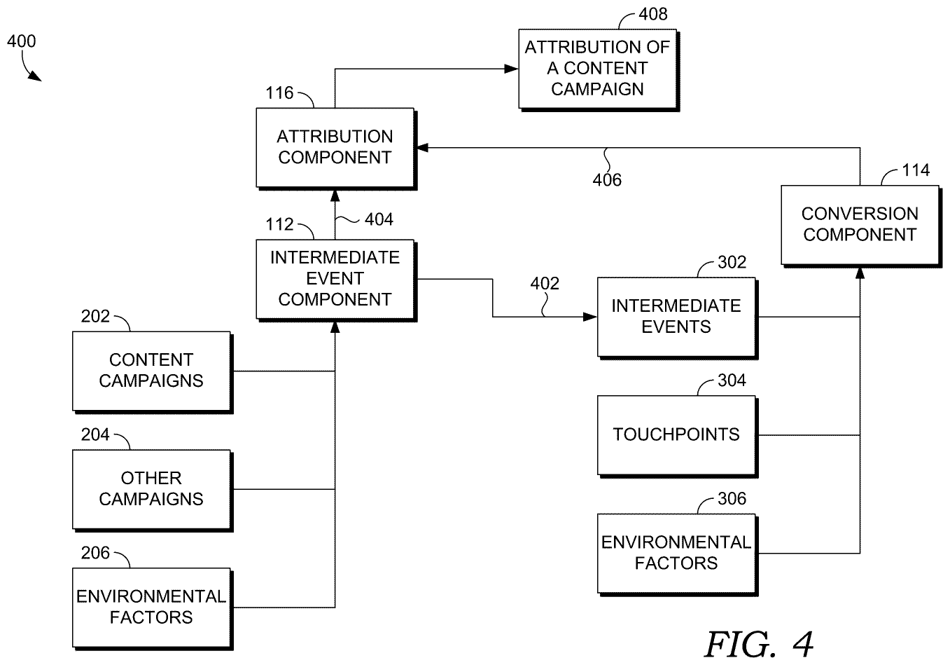

FIG. 4 provides a block diagram showing an example illustrating the operations of the attribution component 116. Attribution component 116 merges the results from the intermediate event component 112 and the conversion component 114 to determine an attribution of a specific content campaign to conversions. In other words, the attribution component 116 determines an attribution of a content campaign to conversions as a function of the attribution of the content campaign to intermediate events (e.g., generated by the intermediate event component 112) and the attribution of the intermediate events to conversions (e.g., generated by the conversion component 114). By using intermediate events to integrate the intermediate event component 112 and the conversion component 114 (e.g., illustrated by arrow 402), the attribution component 116 is able to more accurately generate the attribution of content campaigns to conversions. For instance, in some aspect, the conversion component 114 provides insights into how much of the total revenue (e.g., the amount gained from the conversions) is generated by intermediate events, and the attribution component 116 allocates the revenue from the intermediate events back to each content campaign based on the output of the intermediate event component 112. As such, the attribution component 116 synergizes the insights from the intermediate event component 112 and the conversion component 114 into a multi-stage model.

In some instances, the conversion component 114 is a machine learning model (e.g., an MTA or a rule-based model) that operates on individual-level data to determine contributions of touchpoints to conversions. Traditional models for determining attributions to conversions based on individual-level data, such as MTAs, are not an ideal model to measure the contributions of content campaigns since individual-level data is not available for the content campaigns. Unlike such traditional models, the conversion component 114 identifies a particular type of touchpoint as an intermediate event and determines the attribution of the intermediate event to conversions. Additionally, conventional MMM is configured to measure the attribution of content campaigns to conversions. Unlike such conventional MMM, the intermediate event component 112 determines the attribution of content campaigns to intermediate events. By linking the intermediate event component 112 and the conversion component 114 using intermediate events, the attribution component 116 of the analytics system 104 generates an attribution of content campaigns to conversions using the outputs of the intermediate event components 112 and the conversion component 114 (e.g., illustrated by arrows 404 and 406).

As such, the combination of the results from the intermediate event component 112 and the conversion component 114 are used by the attribution component 116 to determine an attribution of a content campaign 408 to conversions. For example, a provider could air a TV advertisement on a television station on January 1^{st}, and the attribution component 116 determines that this TV advertisement generated $5,000 on January 2^{nd}. In this example, the attribution component 116 could provide the breakdown for the time periods regarding either (or both) a touchpoint (e.g., intermediate event) or a conversion. Alternatively, or in addition, the attribution component 116 may determine the revenue for a specific product or service, a category of products or service, or all products or services offered by a provider. Accordingly, the revenue generated from a content campaign—out of the total revenue earned by a provider—can be generated by the attribution component 116. For instance, the attribution component 116 may determine that a specific intermediate event (e.g., free signups for a provider, for example) accounted for 10% of revenue over a given time period, and the attribution component 116 could determine that a particular content campaign produced 10% of the intermediate event, which allows the attribution component 116 to generate an attribution of 1% of total revenue associated with the particular content campaign. Therefore, the attribution component 116 of the analytics system 104 generates an attribution of a content campaign 408 to the conversions.

The analytics system 104 further includes a user interface component 118 that provides one or more user interfaces for interacting with the analytics system 104. The user interface component 118 provides one or more user interfaces to a user device, such as the user device 102. In some instances, the user interfaces can be presented on the user device 102 via the application 108, which can be a web browser or a dedicated application for interacting with the system 104. For instance, the user interface component 118 can provide user interfaces for, among other things, providing the attributions of a content campaign to a specified intermediate event generated by the intermediate event component 112 based on content campaign data, intermediate event data, and environmental factors associated with a content campaign. In some instance, the user interface component 118 can provide user interfaces for providing the attributions of an intermediate event to a specified conversion generated by the conversion component 114 based on individual-level touchpoint data, including individual-level conversion data, and environmental factors. In other instances, the user interface component 118 can provide user interfaces for providing an attribution of a content campaign to conversions generated by the attribution component 116 based on the results of the intermediate event component 112 and the conversion component 114. As such, the user interface component 118 can generate a user interface presenting the attribution of a content campaign to conversions. Furthermore, the user interface component 118 can communicate the user interface over a network to a client computing device.

In aspects, a user of the analytics system 104 (e.g., via the user interface component 118) can specify certain data and/or time periods for determining attributions. For example, the user could specify a time period for conversions (e.g., conversions on a certain day or for a certain month), specify a time period for intermediate events (e.g., intermediate events that occurred on a certain day or within a certain month) and/or specify a time period for campaigns (e.g., a given month of a campaign). As such, the user can control the inputs to the models to determine the attribution for the time period(s) specified by the user. In some examples, the user could specify the type of input for the content campaigns (e.g., spend versus impressions). In other examples, the user could specify the product(s)/service(s) for the conversions (e.g., specific product/service, category of product/service, etc.). In further examples, the user could specify the type of touchpoint to use as the intermediate event. As such, the user can control the inputs to the models to determine the attribution for the aspects specified by the user. Accordingly, the user could enter a prompt such as “give me the attribution of spend for campaign A during March to conversions for product B” or “provide the attribution of all impressions for campaign A to conversions of product category X on day Y.”

### Example Methods for Content Campaign Attribution Via Model Integration

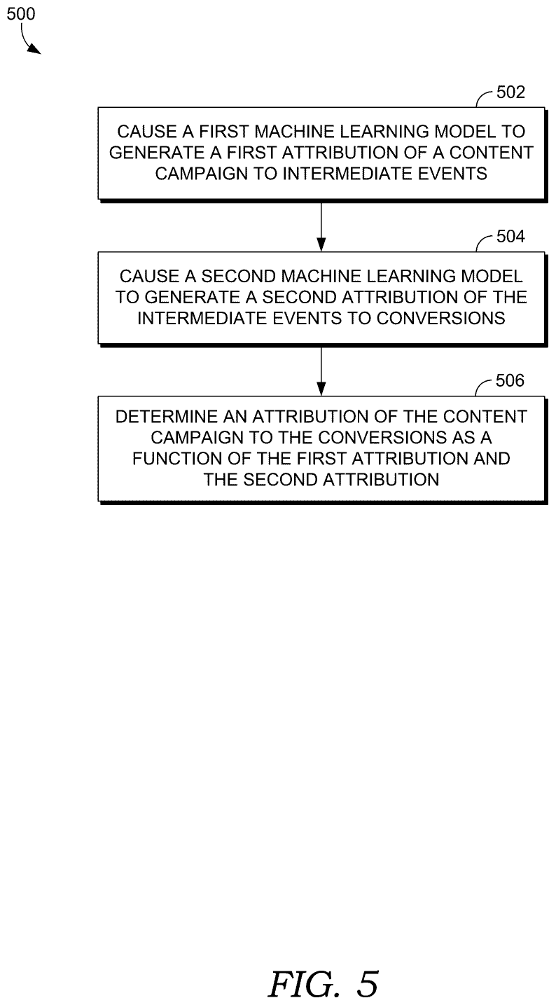

With reference now to FIG. 5, a flow diagram is provided that illustrates a method 500 for determining an attribution of a content campaign to conversions by integrating two machine learning models. The method 500 can be performed at least in part, for instance, by the analytics system 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

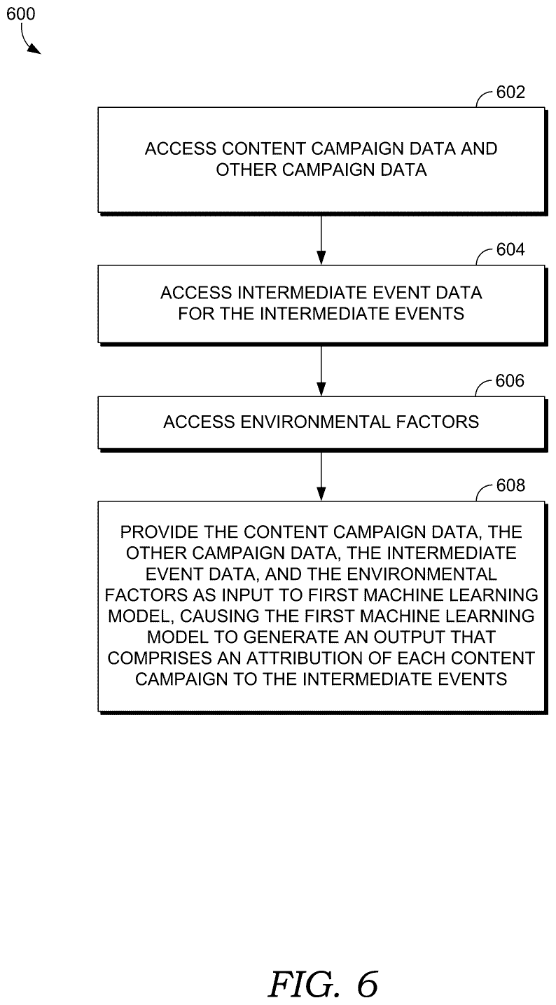

As shown at block 502, a first machine learning model, such as a model of the intermediate event component 112 employing media mix modeling (MMM), is caused to generate a first attribution of a content campaign to intermediate events (e.g., using the method 600 described below with reference to FIG. 6). In contrast to conventional MMM that determines the attribution of content campaigns to conversions, the first machine learning model generates the attribution of content campaigns to intermediate events. Examples of intermediate events include free signups (e.g., creating an account with a provider), free trials, adding items to cart, clicks on an advertisement, website visits, content downloads, email sign-ups, and more.

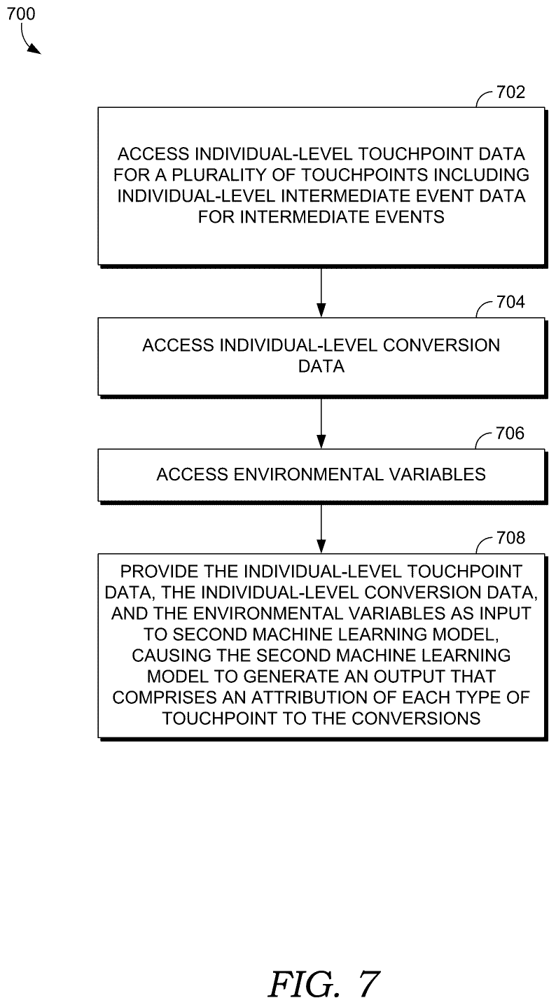

At block 504, a second machine learning model, such as a multi-touch attribution (MTA) model of the conversion component 114, is caused to generate a second attribution of the intermediate events to conversions (e.g., using the method 700 described below with reference to FIG. 7). Unlike traditional models, the second machine learning model identifies an intermediate event as a particular type of touchpoint and determines the attribution of the intermediate event to conversions.

At block 506, an attribution of the content campaign to the conversions is determined, for instance, by the attribution component 116, as a function of the first attribution (e.g., of a content campaign to intermediate events) and the second attribution (e.g., of the intermediate events to conversions). For instance, the attribution component 116 merges the results from the intermediate event component 112 and the conversion component 114 to determine an attribution of a specific content campaign to conversions.

Turning next to FIG. 6, a flow diagram is provided that illustrates a method 600 for generating an output that comprises an attribution of content campaigns to intermediate events. The method 600 can be performed, for instance, by the intermediate event component 112 of FIG. 1. As shown at block 602, content campaign data and other campaign data are accessed by the intermediate event component 112. The content campaign data can include data for any number of content campaigns that includes a target content campaign. The other campaign data can include data for any number of other campaigns. The content campaign data and other campaign data could include, for instance, campaign spend and/or impression counts for each campaign.

Intermediate event data for the intermediate events is accessed, for instance, by the intermediate event component 112, as shown at block 604. Intermediate event data can include the total number of intermediate events of a particular type that have occurred within a given time period. For example, the total number of signups in a given day would be considered intermediate event data.

As shown at block 606, environmental factors are accessed, for instance, by the intermediate event component 112. Environmental factors refer to any external factor that could potentially affect any given intermediate event. For example, environmental factors can include the SP500 (e.g., as a proxy for the economic environment, which can influence consumer behavior), promotions (e.g., any promotions or special offers that might be running concurrently with the content campaign), seasons (e.g., temporal factors like time of the year, holidays, or specific seasons, which can have a significant impact on consumer behavior and signup trends), and other factors that are capable of affecting intermediate events.

At block 608, the content campaign data, the other campaign data, the other campaign data, the intermediate event data, and the environmental factors are provided, for instance, by the intermediate event component 112, as input to the first machine learning model (which could employ MMM techniques), causing the first machine learning model to generate an output that comprises an attribution of each of the content campaigns to the intermediate events.

Turning next to FIG. 7, a flow diagram is provided that illustrates a method 700 for generating an output that comprises an attribution of touchpoints to conversions. The method 700 can be performed, for instance, by the conversion component 114 of FIG. 1. As shown at block 702, individual-level touchpoint data for various types of touchpoints for a number of individuals is accessed, for instance, by the conversion component 114. The individual-level touchpoint data includes individual-level intermediate event data for intermediate events in addition to individual-level data for other types of touchpoints.

Individual-level conversion data for the individuals is accessed, for instance, by the conversion component 114, as shown at block 704. For instance, the individual-level conversion data for a conversion can include information such as the product or service purchased, the platform on which the conversion occurred, and a timestamp for when the conversion occurred. In some instances, the individual-level conversion data can include data for negative paths—i.e., instances in which one or more touchpoints occurred for an individual but no conversion occurred. At block 706, the conversion component 114 accesses environmental variables. For example, environmental variables can include details of any specific day in which a conversion was made, including the day of the week, the time of day, whether the day was a holiday or not. Moreover, the time between intermediate events and conversions and/or the time between touchpoints and conversions can also be considered an environmental variable.

As shown at block 708, the individual-level touchpoint data, the individual-level conversion data, and the environmental variables are provided, for instance, by the conversion component 114, as input to the second machine learning model, causing the second machine learning model to generate an output that comprises an attribution of each type of touchpoint to the conversions. As such, the output of the conversion component 114 includes attributions of the intermediate events to the conversions.

### Exemplary Operating Environment

Having described implementations of the present disclosure, an exemplary operating environment in which embodiments of the present technology can be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what can be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory can be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which can be built in. Illustrative components include a microphone, joystick, game pad, satellite dish, scanner, printer, wireless device, etc. The I/O components 820 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 can be equipped with depth cameras, such as, stereoscopic camera systems, infrared camera systems, RGB camera systems, and combinations of these for gesture detection and recognition. Additionally, the computing device 800 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
causing a media mix modeling model to generate a first attribution of a content campaign to intermediate events;
causing a multi-touch attribution model to generate a second attribution of the intermediate events to conversions; and
determining an attribution of the content campaign to the conversions as a function of the first attribution and the second attribution.

2. The one or more computer storage media of claim 1, wherein causing the media mix modeling model to generate the first attribution comprises:
accessing content campaign data for a plurality of content campaigns that includes the content campaign;
accessing intermediate event data for the intermediate events;
accessing environmental factors; and
providing the content campaign data, the intermediate event data, and the environmental factors as input to the first machine learning model, causing the media mix modeling model to generate an output that comprises an attribution of each of the plurality of content campaigns to the intermediate events.

3. The one or more computer storage media of claim 2, wherein causing the media mix modeling model to generate the first attribution further comprises:
accessing a time period associated with each content campaign from the plurality of content campaigns; and
providing the time period for each content campaign as input to the first machine learning model.

4. The one or more computer storage media of claim 1, wherein causing the multi-touch attribution model to generate the second attribution comprises:
accessing individual-level touchpoint data for a plurality of touchpoints for a plurality of individuals, the individual-level touchpoint data comprising individual-level intermediate event data for the intermediate events;
accessing individual-level conversion data for the conversions for the plurality of individuals;
accessing environmental variables; and
providing the individual-level touchpoint data, the individual-level conversion data, and the environmental variables as input to the multi-touch attribution model, causing the multi-touch attribution model to generate an output that comprises an attribution of each type of touchpoint to the conversions.

5. The one or more computer storage media of claim 4, wherein causing the multi-touch attribution model to generate the second attribution further comprises:
accessing a time lag associated with each touchpoint from the plurality of touchpoints; and
providing the time lag for each touchpoint as input to the multi-touch attribution model.

6. The one or more computer storage media of claim 1, wherein the operations further comprise:
generating a user interface presenting the attribution of the content campaign to the conversions; and
communicating the user interface over a network to a client computing device.

7. A computer-implemented method comprising:
causing, by an intermediate event component, a first machine learning model to generate a first attribution of a content campaign to intermediate events;
causing, by a conversion component, a second machine learning model to generate a second attribution of the intermediate events to conversions;
determining, by an attribution component, the attribution of the content campaign to the conversions as a function of the first attribution and the second attribution; and
generating, by a user interface component, a user interface presenting the attribution of the content campaign to the conversions.

8. The computer-implemented method of claim 7, wherein the first machine learning model is a media mix modeling model.

9. The computer-implemented method of claim 7, wherein the second machine learning model is a multi-touch attribution model.

10. The computer-implemented method of claim 7, wherein causing the first machine learning model to generate the first attribution comprises:
accessing content campaign data for a plurality of content campaigns that includes the content campaign;
accessing intermediate event data for the intermediate events;
accessing environmental factors; and
providing the content campaign data, the intermediate event data, and the environmental factors as input to the first machine learning model, causing the first machine learning model to generate an output that comprises an attribution of each of the plurality of content campaigns to the intermediate events.

11. The computer-implemented method of claim 10, wherein causing the first machine learning model to generate the first attribution further comprises:
accessing a time period associated with each content campaign from the plurality of content campaigns; and
providing the time period for each content campaign as input to the first machine learning model.

12. The computer-implemented method of claim 7, wherein causing the second machine learning model to generate the second attribution comprises:
accessing individual-level touchpoint data for a plurality of touchpoints for a plurality of individuals, the individual-level touchpoint data comprising individual-level intermediate event data for the intermediate events;
accessing individual-level conversion data for the conversions for the plurality of individuals;
accessing environmental variables; and
providing the individual-level touchpoint data, the individual-level conversion data, and the environmental variables as input to the second machine learning model, causing the second machine learning model to generate an output that comprises an attribution of each type of touchpoint to the conversions.

13. The computer-implemented method of claim 12, wherein causing the second machine learning model to generate the second attribution further comprises:
accessing a time lag associated with each touchpoint from the plurality of touchpoints; and
providing the time lag for each touchpoint as input to the second machine learning model.

14. The computer-implemented method of claim 7, wherein the operations further comprise communicating the user interface over a network to a client computing device.

15. A computer system comprising:
one or more processors; and
one or more computer storage media storing computer-useable instructions that, when used by the one or more processors, causes the computer system to perform operations comprising:
generating, by an intermediate event component, a first attribution of a content campaign to intermediate events by:
accessing content campaign data for a plurality of content campaigns that includes the content campaign,
accessing intermediate event data for the intermediate events,
accessing environmental factors, and
providing the content campaign data, the intermediate event data, and the environmental factors as input to a first machine learning model, causing the first machine learning model to generate an output that comprises an attribution of each of the plurality of content campaigns to the intermediate events;
generating, by a conversion component, a second attribution of the intermediate events to conversions by:
accessing individual-level touchpoint data for a plurality of touchpoints for a plurality of individuals, the individual-level touchpoint data comprising individual-level intermediate event data for the intermediate events,
accessing individual-level conversion data for the conversions for the plurality of individuals,
accessing environmental variables, and
providing the individual-level touchpoint data, the individual-level conversion data, and the environmental variables as input to the second machine learning model, causing the second machine learning model to generate an output that comprises an attribution of each type of touchpoint to the conversions;
determining, by an attribution component, an attribution of the content campaign to the conversions as a function of the first attribution and the second attribution; and
communicating, by a user interface component, the attribution of the content campaign to the conversions over a network to a client computing device.

16. The computer system of claim 15, wherein the first machine learning model is a media mix modeling.

17. The computer system of claim 15, wherein the second machine learning model is a multi-touch attribution model.

18. The computer system of claim 15, wherein generating, by the intermediate event component, the first attribution of the content campaign to intermediate events further comprises:
accessing a time period associated with each content campaign from the plurality of content campaigns; and
providing the time period for each content campaign as input to the first machine learning model.

19. The computer system of claim 15, wherein generating, by the conversion component, the second attribution of the intermediate events to conversions further comprises:
accessing a time lag associated with each touchpoint from the plurality of touchpoints; and
providing the time lag for each touchpoint as input to the second machine learning model.

20. The computer system of claim 15, wherein communicating, by the user interface component, the attribution of the content campaign to the conversions over the network to the client computing device comprises:
generating a user interface presenting the attribution of the content campaign to the conversions; and
communicating the user interface over the network to the client computing device.
